(19) United States
(12) Patent Application Publication
(10) Pub. No.: US 2013/0332120 A1
(43) Pub. Date: Dec. 12, 2013

(54) SYSTEM AND METHOD FOR AGGREGATING RESERVOIR CONNECTIVITIES

(71) Applicants: Minshen HAO, Los Angeles, CA (US); Jerry M. MENDEL, Los Angeles, CA (US)

(72) Inventors: Minshen HAO, Los Angeles, CA (US); Jerry M. MENDEL, Los Angeles, CA (US)

(73) Assignee: University of Southern California, Los Angeles, CA (US)

(21) Appl. No.: 13/740,119

(22) Filed: Jan. 11, 2013

Related U.S. Application Data
(60) Provisional application No. 61/656,396, filed on Jun. 6, 2012.

(51) Int. Cl. G06F 17/50

(52) U.S. Cl. CPC G06F 17/5009
USPC 703/2

(57) ABSTRACT

Described herein is a method of predicting production rates of one or more wells configured to extract petroleum from a petroleum reservoir, the production rates affected by one or more injectors configured to inject water into the petroleum reservoir, the method comprising: calculating a relationship parameter, using a plurality of models, for each of the one or more wells and an associated one of the one or more injectors; predicting future values of the relationship parameter calculated using the plurality of model; calculating a weighted aggregate of the future values of the relationship parameter, wherein weights for the future values are those that minimize a prediction error; predicting the production rates using the a weighted aggregate.

### BACKGROUND

The present application claims priority from U.S. Provisional Patent Application No. 61/586,396, filed Jan. 13, 2012, the complete disclosure of which is incorporated herein by reference in its entirety for all purposes.

### FIELD

The present disclosure relates generally to modeling reservoir production and more particularly to estimation of injector-producer connectivities and the resulting effects on second-stage resource recovery.

### BACKGROUND

Flooding an oil field with water has been a widely accepted method for increasing a reservoir's oil recovery since the 1950's. In this method, water is injected into dedicated injection wells strategically located throughout the reservoir, in order to displace the remaining oil towards the producing wells. If properly designed and operated, a waterflood can double the reservoir's oil recovery.

In almost all waterflood operations, measured injection and production rates are the most abundant available data. They are considered to be correlated to each other in some very complicated way, and many methods have been previously proposed to infer the interwell connectivities (which may be referred to as the “Injector-Producer-Relationship (IPR)”) between each producer and its surrounding contributing injectors using only these data. Generally, the reservoir is modeled as a dynamical system in which the injection rates act as the system's inputs and the production rates are the system's outputs.

In practice, the IPR is estimated using a model so that water can be allocated in an optimal manner. Water is a resource that can be expensive, and so its optimal allocation can reduce the costs for extracting petroleum from a reservoir; however, multiple models for IPR estimation exist and they do not necessarily yield the same estimation. It can be difficult to tell which model should be used.

The disclosure herein provides optimized aggregation of estimated IPRs from different models and thus reduces errors in predicted production rates of the producing wells.

### SUMMARY

Described herein is a method of predicting production rates of one or more wells configured to extract petroleum from a petroleum reservoir, the production rates affected by one or more injectors configured to inject water into the petroleum reservoir, the method comprising calculating a relationship parameter, using a plurality of models, for each of the one or more wells and an associated one of the one or more injectors; predicting future values of the relationship parameter calculated using the plurality of models; calculating a weighted aggregate of the future values of the relationship parameter, wherein weights for the future values are those that minimize a prediction error; predicting the production rates using the weighted aggregate.

According to an embodiment, the relationship parameter represents a relationship between a step change in injection rate of the one injector and production rate of the one well.

According to an embodiment, the plurality of model comprises Liu-Mendel Model.

According to an embodiment, the plurality of model comprises Distributed Capacitance Model.

According to an embodiment, the relationship parameter is a function of time.

According to an embodiment, the relationship parameter is affected by factors selected from a group consisting of bottom-hole pressures, workovers, geomechanical effects, and combination thereof.

According to an embodiment, future values of the relationship parameter are predicted by Extended Kalman Filter (EKF).

According to an embodiment, future values of the relationship parameter are predicted by Extended Kalman Smoother (EKS).

According to an embodiment, the weights are calculated using quantum particle swarm optimization.

According to an embodiment, the plurality of model comprises Square-Root Liu-Mendel Model.

According to an embodiment, the plurality of model comprises Square-Root Distributed Capacitance Model.

According to an embodiment, the plurality of model comprises Non-Square-Root Liu-Mendel Model.

According to an embodiment, the plurality of model comprises Non-Square-Root Distributed Capacitance Model.

An aspect of an embodiment may include a system for performing any of the foregoing methods.

An aspect of an embodiment of the present disclosure includes a system including a data storage device and a processor, the processor being configured to perform the foregoing method.

Aspects of embodiments of the present disclosure include non-transitory computer readable media encoded with computer executable instructions for performing any of the foregoing methods and/or for controlling any of the foregoing systems.

Any or all of the calculation described herein may be executed on a computer.

### DESCRIPTION OF THE DRAWINGS

Other features described herein will be more readily apparent to those skilled in the art when reading the following detailed description in connection with the accompanying drawings, wherein:

FIG. 1 is a schematic illustration of a flow field relating injectors to producers in a reservoir;

FIG. 2 is a reservoir model in which a producer is acted upon by N injectors;

FIG. 3 is a timing diagram for the Iterated Extended Kalman Filter (IEKF) applied to data over a period of N days;

FIG. 4 is a timing diagram for an aggregation approach in accordance with an embodiment;

FIG. 5 is a flowchart for implementation of an aggregation approach in accordance with an embodiment;

FIG. 6 is a flowchart for evaluating an aggregation approach in accordance with an embodiment;

FIG. 7 illustrates Root Mean Square Errors (RMSE) results for producer 1 when aggregating IPR estimates from Square-Root Liu-Mendel Model (SRLMM) and Square-Root Distributed Capacitance Model (SRDCM) using the Generalized Choquet Integral (GCI);

FIG. 8 illustrates RMSE results for producer 7 when aggregating IPR estimates from SRLMM and SRDCM using a GCI;

FIG. 9 illustrates RMSE results for producer 10 when aggregating IPR estimates from SRLMM and SRDCM using a GCI;

FIG. 10 illustrates RMSE results for producer 1 when aggregating four IPRs using the GCI;

FIG. 11 illustrates RMSE results for producer 7 when aggregating four IPRs using the GCI; and

FIG. 12 illustrates RMSE results for producer 10 when aggregating four IPRs using the GCI.

FIG. 13 shows a schematic computer configured to execute any or all of the calculation described herein.

### DETAILED DESCRIPTION

In accordance with an embodiment, multiple models are produced, then parameters are estimated and smoothed in each model using an Iterated Extended Kalman Filter (IEKF) and an Extended Kalman Smoother (EKS). Any number of models may be used as well as different types of IPR models known to those of skill in the art. Then different IPR estimates obtained for the different models are aggregated, so that the aggregated IPR estimates produce less production rate prediction error for all the models. Note that it is not generally required to aggregate the IPR estimates in real time, because water is re-allocated on a daily (or even less frequent) basis. However, in some embodiments, the real time IPR estimates may be aggregated in real time.

In an embodiment, a first model that may be used is the Liu-Mendel Model (LMM). However, it is contemplated, in other embodiments, any suitable parametric IPR models known to those of skill in the art may be used. FIG. 1 shows a portion of a reservoir consisting of 6 injectors and 3 producers. In this reservoir, the production rates of producer P1 are determined by injectors I1, I2, I5 and I6 (as indicated by arrows); production rates of producer P2 are determined by injectors I2, I3, I4 and I5; and production rates of P3 are determined by I4, I5 and I6. Injectors that determine a producer's production rates are called the producer's contributing injectors, i.e., injectors I1, I2, I5 and I6 are P1's contributing injectors, etc. Models that view the whole reservoir in this manner are called producer-centric models, and producers are assumed to be independent of each other in these models.

In LMM, the reservoir is considered to be a system that can be modeled as a collection of continuous-time impulse responses that convert injection rates into a production rate. A reservoir in which a producer is acted upon by N injectors is depicted in FIG. 2, where Iⱼ(t), nⱼ(t) and I^{m}(t) are the actual injection rates that flow into the reservoir, the corresponding measurement noises for measuring injection rates, and the measured injection rates for injector j, respectively, and j=1, 2, . . . , N; P(t), n_{P}(t) and P^{m}(t) are the actual production rate, the corresponding measurement noise for measuring the production rate, and the measured production rate, respectively; P^{e}(t) is the channel production rate produced by injector j, which represents the amount of production rate in P(t) caused only by injector j. Note that this reservoir model is analogous to a digital communication system, where injection rates are the messages, hⱼ(t) (j=1, . . . , N) act as channels that distort the messages, and P(t) is the received signal which can only be observed with additive noise. Also note that the noise-free data, Iⱼ(t) (j=1, 2, . . . , N) and P(t) are not directly available. Their measured values, I^{m}(t) and P^{m}(t), are used for later data processing.

As shown in FIG. 2, each injector/producer pair is considered as an independent subsystem, and each subsystem is modeled as a continuous-time impulse response that converts the injection rate, Iⱼ(t), into production rate P_{c}(t). In the LMM, the following two-parameter auto-regressive (AR) model is used to represent the impulse response between a producer and injector j:

hⱼ(t)=f(rⱼ, kⱼ)bⱼte^{-a}^{ⱼ}^{t} (1)

where f(rⱼ, kⱼ) (j=1, . . . , N) is a scale function that represents how much of each injection rate flows in the direction of a producer; it may be a linear or non-linear scalar function of the distance, rⱼ, and the permeability, kⱼ, between the producer and injector j; but, this is unimportant because f(rⱼ, kⱼ) and bⱼ are absorbed into a single unknown parameter (γ′ⱼ in (2)). Only sampled injection and production rates are available for processing, hence, (1) is discretized.

A unit step change of an injection rate causes a step change of steady-state production rate, whose impact can be evaluated by the IPR value, where 0≧IPR≧1. Furthermore, the numerical IPR value between injector j and a producer is the area under the discretized impulse response, and the following formula may be used for the IPR:

$${IPR}_{j} = \frac{{γ}_{j} f ( {r}_{j} , {k}_{j} )}{{( 1 - {α}_{j} )}^{2}} = \frac{{γ}_{j}^{′}}{{( 1 - {α}_{j} )}^{2}} \qquad ( 2 )$$

where αⱼ=e^{-a}^{ⱼ}^{T}, γⱼ=bⱼαⱼT and T is the sample period.

Using the discretized impulse response and (2), the subsystem between a producer and injector j can then be modeled as the following second-order finite-difference equation:

Pⱼ^{e}(k+1)=2αⱼ(k)Pⱼ^{e}(k)−αⱼ²(k)Pⱼ^{e}(k−1)+γⱼ(k)Iⱼ(k) (3)

Note that in (3) αⱼ and γⱼ are dependent on k, as is commonly done in system identification when an unknown parameter is modeled as a Markov process. In practice, the measurement noise of injection rate Iⱼ(k) is very small, so that it can be replaced by the measured injection rate, Iⱼ^{m}(k); hence, (3) is re-expressed, as:

Pⱼ^{e}(k+1)=2αⱼ(k)Pⱼ^{e}(k)−αⱼ²(k)Pⱼ^{e}(k−1)+γⱼ(k)Iⱼ^{m}(k) (4)

or equivalently, using (2), as

Pⱼ^{e}(k+1)=2αⱼ(k)Pⱼ^{e}(k)−αⱼ²(k)Pⱼ^{e}(k−1)+IPRⱼ(k)[1−αⱼ(k)]²Iⱼ^{m}(k) (5)

Note that (5) is the LMM channel equation used in this paper, where both IPRⱼ(k) and αⱼ(k) (or their square roots) are modeled as first-order Markov sequences, i.e.,

IPRⱼ(k+1)=IPRⱼ(k)+n_{IPRj}(k) (6)

αⱼ(k+1)=60 ⱼ(k)+n_{αj}(k) (7)

where n_{IPRj}(k) and n_{αj}(k) are zero-mean additive white noises. (5)-(7) constitute a nonlinear discrete-time stochastic system.

In a further embodiment, a Distributed Capacitance Model (DCM) may be used as a model. The DCM can be viewed as a generalization of the capacitance model to include the case where there exists a high permeability channel or fracture that divides the reservoir into two parts. The DCM is also a producer-centric model in which the relationship between one producer and all its contributing injectors can also be represented by FIG. 2, but now the channel between injector j and a producer is described by a three-parameter impulse response, as:

$${h}_{j} ( t ) = \frac{{λ}_{j}}{{τ}_{j 1} - {τ}_{j 2}} ( ɛ \text{?} - ɛ \text{?} ) \\ \text{?} \text{indicates text missing or illegible when filed} \qquad ( 8 )$$

where and τⱼ₁ and τⱼ₂ are the “time constants” of the drainage volume and λj denotes the normalized interwell connectivity between injector j and the producer.

Using the discretized version of (8) and the area under the discretized hⱼ(t) for the IPR, it follows that the IPR (0≦IPR≦1) in the DCM can be computed as:

$${IPR}_{j} = \frac{{γ}_{j} ( {α}_{j 1} - {α}_{j 2} )}{1 - ( {α}_{j 1} + {α}_{j 2} ) + {α}_{j 1} {α}_{j 2}} \qquad ( 9 )$$

where αⱼ₁=e^{-T/τ}^{ⱼ₁}, αⱼ₂=e^{-T/τ}^{ⱼ₂}, γⱼ=λⱼ/(τⱼ₁−τⱼ₂) and T is the sampling period. Using the discretized version of (8) and the IPRⱼ in (9), the DCM model is described as:

$${P}_{j}^{c} ( k + 1 ) = \vert {α}_{j 1} ( k ) + {α}_{j 2} ( k ) \vert {P}_{j}^{c} ( k ) - {α}_{j 1} ( k ) {α}_{j 2} ( k ) {P}_{j}^{c} ( k - 1 ) + {IPR}_{j} ( k ) \{ 1 - [ {α}_{j 1} ( k ) + {α}_{j 2} ( k ) ] + {α}_{j 1} ( k ) {α}_{j 2} ( k ) \} {I}_{j}^{m} ( k ) \qquad ( 10 )$$

As in (4) and (5), Iⱼ(k) is replaced by its measurement Iₘ(k) (j=1, . . . , N). Equation (10) is the DCM channel equation, where IPRⱼ(k), αⱼ₁(k) and αⱼ₂(k) (or their square roots) are modeled as first-order Markov sequences, analogous to (6) and (7) above. This is also a nonlinear discrete-time stochastic system.

In an embodiment, the EKF and IEKF may be used for recursive dynamic nonlinear estimation. However, other recursive nonlinear estimation methods known to those of skill in the art may also be used. The EKF and IEKF provide a first-order approximation of optimal nonlinear mean-square state estimation for a nonlinear discrete-time system. The IEKF differs from the EKF in that it iterates the EKF correction equation until a stopping criterion is met; in general, it provides a better estimate than the EKF.

Assuming the IPRs and other channel parameters are not static, it may be preferred to use the IEKF. In practice, IPRs may be affected by many factors, e.g., changing of bottom-hole pressures, workovers, natural or man-made geomechanical effects, etc.

The IEKF and Extended Kalman Predictor (EKP) equations are based on the following State-Variable Model (SVM):

$$\{ \begin{matrix}x ( k + 1 ) = f [ x ( k ) , k ] + {n}_{x} ( k ) \\ z ( k + 1 ) = h [ x ( k + 1 ) , k + 1 ] + {n}_{z} ( k + 1 )\end{matrix} \qquad ( 11 )$$

where f and h are the state and measurement equations, respectively, and nₓ(k) and n_{z}(k) are additive zero-mean white noises for the state and measurement, with covariance matrix Q(k) and variance r(k), respectively.

To use the IEKF and EKP, it is useful to construct an SVM. In embodiments, four different SVMs are used: two for the LMM, and two for the DCM. How to construct such SVMs is illustrated in Appendices A and B for a simple 3-injector 1-producer reservoir. However, in other embodiments, any number of SVMs may be used. The examples may be generalized by one of skill in the art to the multiple-injector case.

IEKF and EKP processing provide filtered and predicted state estimates of x(k+1), \hat{x}(k+1|k+1) and \hat{x}(k+1|k) respectively, the former using all the measurements up to and including time k+1, and the latter using the measurements up to time k. Details of how to run the IEKF and EKP based on an SVM are familiar to those of skill in the art.

Using an SVM, one can also perform another kind of state estimation, called smoothing (or interpolation) [16], [23]. A smoothed estimate of x(k) not only uses measurements that occur up to and including k, but also uses measurements to the right (future) of k. Smoothed estimates of IPR may be better than filtered estimates of IPR because they make use of more data. Depending on how many future measurements are used and how they are used, there are three types of smoothers: fixed interval, fixed point and fixed lag. In an embodiment, a fixed-interval smoother may be used. In a particular application, the fixed-interval smoother may be the EKS, \hat{x}(k|N) where k=0; 1, . . . , N−1, where N is a fixed positive integer. The situation is as follows [16]: with an experiment completed, there are measurements available over the fixed interval 1≦k≦N. For each time point within this interval an estimate of state vector x(k), is obtained based on all available measurement data {z(j); j=1; 2, . . . , N}.

In this section, we first review some basic concepts behind the theory of fuzzy measures, and then define the Generalized Choquet Integral (GCI).

Definition 1: Let X={x₁, . . . , xₙ} be any finite set. A discrete fuzzy measure on X is a function μ: 2^{X}→[0, 1] with the following properties:

1) μ(ø)=0 and μ(X)=1;

2) given A, B∈2^{x} if A⊂B then μ(A)≦μ(B), i.e., X is monotonic.

The set X is considered to contain the names of sources of information (in the present case, X is the set of all models), and for a subset A⊂C, μ(A) is the worth of A. The Sugeno λ-measure is a special class of fuzzy measures, denoted g.

Definition 2: Let X={x₁, . . . , xₙ} be any finite set and let λ∈[−1, +28]. A Sugeno λ-measure is a function g from 2^{X} to [0,1] with the following properties:

1) g(X)=1;

2) if A, B [symbol] X with A∩B=ø, then

g(A∪B)=g(A)+g(B)+λg(A)g(B)▪ (12)

The measure of a singleton set {xᵢ}, denoted gᵢ=g({xᵢ}), is called a fuzzy density of the information source xᵢ, and λ satisfies the following property:

$$λ + 1 = {\prod }_{i = 1}^{n} ( 1 + λ {g}_{i} ) \qquad ( 13 )$$

It has been shown that the equation (13) has a real root greater than −1 and is soluble. From equations (12) and (13), a Sugeno λ-measure on a set X with n elements may be computed as long as the n fuzzy densities gᵢ can be specified. It may not be possible to specify all of the fuzzy densities because the particular densities that might be optimal in terms of prediction errors may not be known in advance.

Definition 3: Let f be a function from X={x₁, . . . , xₙ} to [symbol] . Let {x_{σ(i)}, . . . , x_{σ(n)}}. The discrete GCI of f with respect to the Sugeno λ-measure g on X is:

$$\begin{matrix} {C}_{g} ( f ) = \text{?} g ( {A}_{( i )} ) ( f ( \text{?} ) - f ( \text{?} ) ) \\ = \text{?} f ( {x}_{σ ( i )} ) ( g ( {A}_{( i )} ) - g ( \text{?} ) )\end{matrix} \\ \text{?} \text{indicates text missing or illegible when filed} \qquad ( 14 )$$

where f(x_{σ(0)})≡0 and A₍ₙ₊₁₎≡Ø, i.e., g(A₍ₙ₊₁₎=0.

The function f is a particular instance of the partial support supplied by each source of information. The GCI fuses this objective support according to the worth of various subsets of the information sources. In practice (14) is computed as follows:

1) Determine the f function. In an embodiment, f is an IPR estimate obtained from an EKS.

2) Compute λ using the given (or, in an embodiment, optimized by means of QPSO—see below) fuzzy densities by solving (13).

3) g(A₍ᵢ₎), i=1, . . . , n, according to (12).

4) Compute C_{g}(f), with quantities computed above, using (14).

QPSO (quantum particle swarm optimization) is a globally convergent search algorithm which generally outperforms the original PSO in search ability and has fewer parameters to control. It is a population-based optimization technique, where a population is called a swarm, that contains a set of different particles. Each particle represents a possible solution to an optimization problem (minimization problem in the present case). During each iteration, the position of each particle is updated using its most recent own best solution, best solutions found by all other particles, and the global best solution found by all particles so far.

Let M denote the population size and n denote the number of dimensions of the search space. Each individual particle I (1≦i≦M), at iteration t, has the following attributes: A current position in the search space Xᵢ(t) and a personal best (pbest) position Pᵢ(t) (the position giving the best fitness found by this particle). Also, the global best (gbest) position found by all particles during iterations up to t, P_{g}(t), is defined as:

$${P}_{g} ( t ) = arg {min}_{{P}_{i}} f ( {P}_{i} ( t ) ) , 1 \leq i \leq M \qquad ( 15 )$$

where the function f is the fitness. Note that each particle represents a set of fuzzy densities for the GCI to compute the aggregated IPR estimates, and every element in Xᵢ(t) (i=1, . . . , M) is constrained to be between 0 and 1 for all t.

At iteration t, the position of particle i, Xᵢ(t), is updated as:

Xᵢ(t+1)=min{max{Pᵢ(t)±β[m(t)−Xᵢ(t)]ln(1/u), 0}, 1} (16)

where 0 and 1 are zero and one vectors with dimension n; β, which controls the convergence speed of the algorithm, is called the contraction-expansion coefficient; m(t) is computed as

$$m ( t ) = \frac{1}{M} {\sum }_{i = 1}^{M} {P}_{i} ( t ) ; \qquad ( 17 )$$

and u is a random number uniformly distributed in (0,1). In an embodiment, β decreases linearly from 1 to 0.5 as the number of iterations increases.

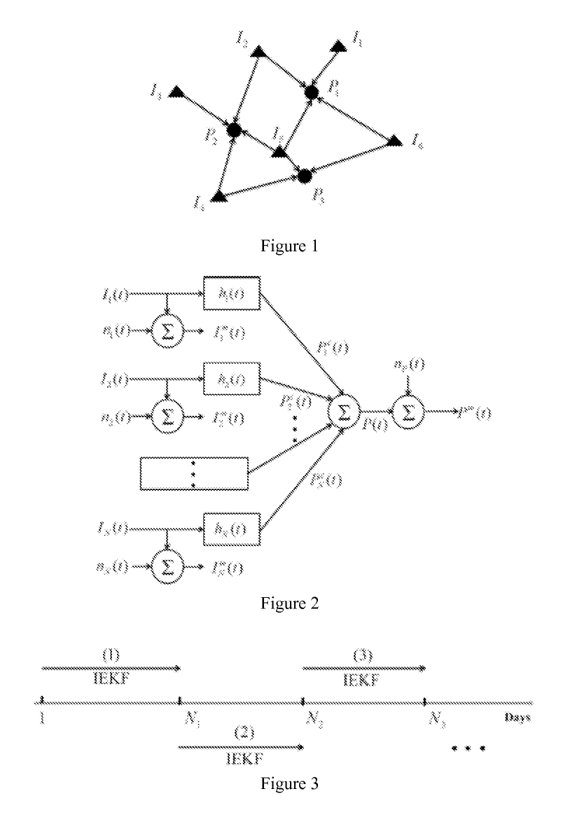

In practice, measured injection and production rate data are not available in real time. Generally speaking, injection rate data are measured daily, but the production rates are only measured on a weekly or bi-weekly basis; hence, IEKF processing on real data cannot be performed in real time. FIG. 3 illustrates how an IEKF may be applied to real data.

At the end of Day N₁, the daily injection and production rates up to Day N₁ are both available. An IEKF (based on any of the SVMs) is run to Day N₁, so that IPR estimates at Day N₁ can be estimated from the state vector of the IEKF. Once new injection and production rates data are measured up to Day N₂, instead of re-estimating everything from the beginning, the IEKF continues to run from Day N₁ to Day N₂, so that IPR estimates at Day N₂ can be computed. In this way, new IPR estimates are obtained at Days k=N₁, N₂, . . . , directly from the IEKF.

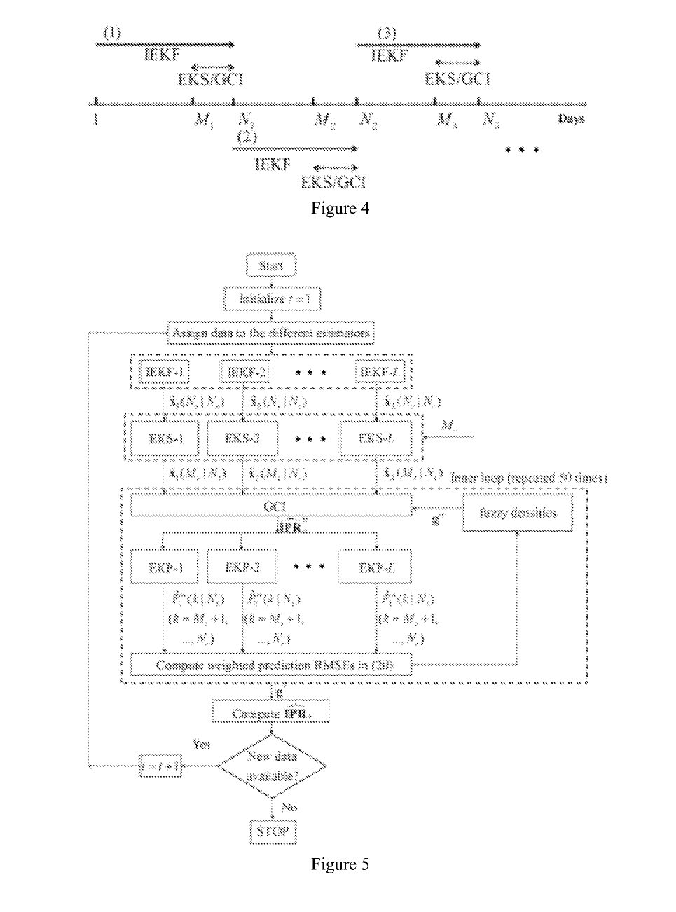

FIG. 4 provides a high-level description of how different IPR estimates obtained from different IEKFs and EKSs are aggregated. As can be seen, it involves filtering from, e.g., N₁ to N₂, smoothing from N₂ to M₂, and aggregation within [M₂,N₂]. These three steps are repeated from N₁ to N₂, N₂ to N₃, . . . , etc. The details of the aggregation approach for a system of one producer and C contributing injectors are explained in this section. Note that the extension of this approach to the multi-injector multi-producer scenario is very straightforward.

To begin, some notations are defined:

1) \hat{x}ₗ(k|k): filtered estimates at Day k from IEKF-l (l=1, . . . , L)

2) \hat{x}ₗ(k|k′): (k′>k): smoothed estimates at Day k using all the measurements up to Day k′ from EKS-l.

3) \hat{x}ₗ(k|k′): (k>k′): predicted estimates at Day k using the measurements up to Day k from EKP-l.

4) [symbol] ₗ≡[ [symbol] ₗ¹, . . . , [symbol] ₗ^{C}]^{T}: IPR estimates of all C injectors from IEKF-l, where [symbol] ₗ^{j} denotes the IPR estimate between injector j and the producer.

5) [symbol] ₐ≡[ [symbol] ₐ¹, . . . , [symbol] ₐ^{C}]^{T}: aggregated IPR estimates.

In an embodiment, a procedure for aggregating the IPR estimates is summarized in FIG. 5. the explanation of the blocks in this figure is as follows (in the following steps, j=1, . . . , C, l=1, . . . , L and w=1, . . . , 20, where C is the number of injectors and L is the number of models:

1) Assign the measured injection and production rates to the different estimators for future use. Connections between this block and the IEFK, EKS, EKP and the RMSE blocks are not shown in FIG. 5, so as not to clutter that figure.

2) Run the L IEKFs to obtain L filtered state estimates \hat{x}ₗ(Nₜ|Nₜ).

3) Use \hat{x}ₗ(Nₜ|Nₜ) and Iⱼ(k), P(k) (k=Mₜ, . . . , Nₜ₎, to run L IEKs back to Day Mₜ, to compute L smoothed estimates \hat{x}ₗ(Mₜ|Nₜ). In this way, all of the available measurements are used to obtain improved estimates of xₗ at the earlier time Mₜ.

4) In the inner loop, the QPSO algorithm is used where each particle in the swarm represents a set of fuzzy densities that correspond to the IPR estimates. The dimension of each particle is CL because there are C injectors and one weight is assigned to each injector/producer pair in all L IEKFs. The goal is to find the fuzzy densities that minimize a prediction error (described below) and then to use those fuzzy densities to aggregate [symbol] ₗ(Mₜ|Nₜ) in order to obtain [symbol] ₐ(Mₜ|Nₜ). In an embodiment, 20 particles and 50 generations are used. Because each fuzzy density represents a worth of its corresponding IPR estimate, it is constrained between 0 and 1. The details of how QPSO is applied are:

a) Randomize 20 particles, and let g^{w}=[g₁^{w}, . . . , g_{CL}^{w}]^{T} denote the current position of an arbitrary particle w, in which g^{w}_{j-1)L+1}, . . . , g^{w}_{jL} are fuzzy densities corresponding to the IPR estimates between injector j and the producer in the L EKSs.

b) for every particle g^{w}, the aggregated IPR estimate between injector j and the producer is computed as:

$$\begin{matrix}{\hat{IPR}}_{a}^{j , w} ( {M}_{t} \vert {N}_{t} ) = {F}_{GCI} [ \text{?} ( {M}_{t} \vert {N}_{t} ) , … , {\hat{IPR}}_{L}^{j} ( {M}_{t} \vert {N}_{t} ) , \\ {g}_{( j - 1 ) 1 + 1}^{w} , … , {g}_{( j - 1 ) L + 1}^{w} ] \\ = {\sum }_{l = 1}^{L} \text{?} ( {M}_{t} \vert {N}_{t} ) [ g ( \text{?} ) - g ( {A}_{σ ( l + 1 )} ) ]\end{matrix} \\ \text{?} \text{indicates text missing or illegible when filed} \qquad ( 18 )$$

In (18), {σ(1), . . . , σ(L)} denotes a reordering of {1, . . . , L} such that [symbol] _{σ(1)}^{j}(Mₜ|Nₜ)≦ . . . ≦ [symbol] _{σ(L)}^{j}(Mₜ|Nₜ) A₍ₗ₎ is defined by A₍ₗ₎={EKS−σ(l), EKS−σ(l+1), . . . , EKS−σ(L)} and g(A₍ₗ₎) is computed using (12) and (13), in which g({EKS−σ(l)})=g^{w}_{(j-1)σ(l)+1}. Denote the aggregated IPR estimates of all C injectors using particle w as [symbol] _{α}^{C,w}(Mₜ|Nₜ)≡[ [symbol] _{α}^{1,w}(Mₜ|Nₜ), . . . , [symbol] _{α}^{C,w}(Mₜ|Nₜ)], where [symbol] _{α}^{j,w}(Mₜ|Nₜ) is computed using (18).

c) Replace the IPR estimates in the L state vector estimates \hat{x}ₗ(Mₜ|Nₜ) with [symbol] _{α}^{w}(Mₜ|Nₜ). Run each of the L EKPs to obtain L production predictions, denoted \hat{P}ₜ^{w}(k|Nₜ), where k=Mₜ+1, . . . , Nₜ.

d) Use actual production rates P(k) (k=Mₜ+1, . . . , Nₜ) and compute 20L weighted prediction RMSEs:

$${J}_{t}^{w} = \sqrt{\frac{1}{{N}_{t} - {M}_{t}} {\sum }_{k = {M}_{i} + 1}^{{N}_{t}} {[ {\hat{P}}_{t}^{w} ( k \vert {N}_{t} ) - P ( k ) ]}^{{2}_{{b}_{k}}}} \qquad ( 19 )$$

where the weights bₖ linearly increase between 0.5 and 1.5 from k=Mₜ+1 to k=Nₜ. Then compute the following 20 average RMSEs:

$${J}_{t}^{w} = \sqrt{\frac{1}{{N}_{t} - {M}_{t}} {\sum }_{m = {M}_{i} + 1}^{{N}_{t}} {[ {\hat{P}}_{t}^{w} ( k \vert {N}_{t} ) - P ( k ) ]}^{{2}_{{b}_{k}}}} \qquad ( 19 )$$

Where J is the objective function minimized by QPSO.

e) Use J to update the personal best weights (P_{w}(t)) that are defined above and then generate the new positions for all 20 particles according to the QPSO algorithm. With the new positions, repeat steps b-e.

f) Terminate the QPSO when b-e are repeated 50 (for example) times. Then output the winner of the QPSO, i.e., the particle (set of weights) that gives the global best weights (P_{g}(t)), denoted g*.

5) Using g*, compute the final aggregated IPR estimates [symbol] _{α}(Mₜ|Nₜ)≡[ [symbol] _{α}¹(Mₜ|Nₜ), . . . , [symbol] _{α}^{C}(Mₜ|Nₜ)] using

[symbol]

_{α}^{j}(Mₜ|Nₜ)=F_{GCI}[ [symbol] ₁^{j}(Mₜ|Nₜ), . . . , [symbol] _{L}^{j}(Mₜ|Nₜ), g*_{(j-1)·L+1}] (21)

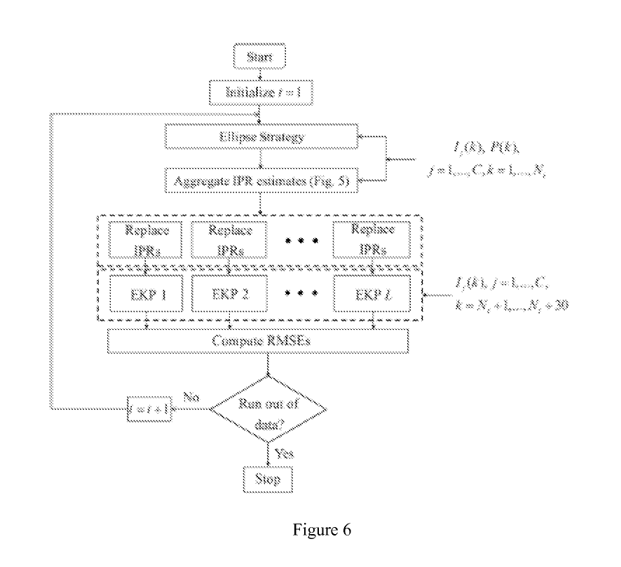

During the aggregation process described above, EKPs are used to predict the production rates from Day Mₜ+1 to Nₜ in order to optimize the fuzzy densities for aggregating the IPR estimates. To evaluate the aggregated IPR estimates, EKPs are also used to predict the production rates from Day Nₜ+1 to Nₜ+30. These predicted production rates are then compared with the historical data. FIG. 6 summarizes a method of evaluating the aggregation approach described above for one producer. The data used is well test data from an actual reservoir, recorded from January 2006 to September 2010 (a total of 1736 days).

In an embodiment, a procedure which may be used to evaluate the aggregation approach is as follows:

1) Choose Mₜ and Nₜ (t=1, . . . , 50) (see FIG. 4), as Mₜ=195+30t and Nₜ=205+30t, i.e., the aggregation approach was performed every 30 days, and for every t, Nₜ−Mₜ=10 days of data were used to optimize the corresponding weights to obtain the aggregated IPR estimates.

2) Use an Ellipse Strategy as described in D. Zhai, J. M. Mendel, and F. Li. A new method for continual forecasting of interwell connectivity in waterfloods using an extended kalman filter, SPE Western Regional Meeting, number 121393-MS, San Jose, Calif., March 2009, which is herein incorporated by reference in its entirety for all purposes, may be used to determine the contributing injectors. The Ellipse Strategy is outlined in brief below:

a) Choose a large enough initial ellipse centered on each producer and use all the injectors within this ellipse to construct an SVM.

b) Shrink the ellipse by different scale factors and use all the injectors within these ellipses to construct different SVMs.

c) For each of the SVMs, run an IEKF and compute average errors between the predicted and actual production rates for the latest number of days of the data. In an embodiment, the number of days of data may range without limitation from 1 day to 360 days.

d) Use the injectors that are contained in the ellipse that gives the minimum averaged prediction error as the contributing injectors for a producer.

For each t, first an ellipse size that included all the possible contributing injectors for this producer was chosen, then the size was shrunk by factors of 0.95, 0.9, 0.85, 0.8 and 0.75; and then, for each size of the ellipse, the injectors contained within it were used as the contributing injectors. For those injectors, the L IEKFs were run to Day Mₜ, and prediction errors were computed for the period k=Mₜ+1, . . . , Nₜ, and the sum of all L prediction errors was computed. The ellipse size that gave the smallest sum of the prediction errors was found, and the injectors in that ellipse were used as the final contributing injectors. Note this step was done before the aggregation approach was used to aggregate the IPR estimates.

3) Apply the aggregation approach described above with the contributing injectors determined in step 2, after which two kinds of estimates were obtained: L smoothed estimates at Day Mₜ, from the L EKSs, \hat{x}ₗ(Mₜ|Nₜ) (l=1, . . . , L), and the aggregated IPR estimate, given by (21).

4) Replace the IPR estimates in \hat{x}ₗ(Mₜ|Nₜ) with the aggregated IPR estimate and denote the resulting vector as \hat{X}ₗ^{a}(Mₜ, Nₜ).

5) Use \hat{X}ₗ^{a}(Mₜ, Nₜ) and the injection rates from Mₜ+1 to Nₜ+30, and run the L EKPs to obtain L predictions of the production rates, namely \hat{P}ₗ^{a}(k, Nₜ), where l=1, . . . , L and k=Mₜ+1, . . . , Nₜ+30.

6) Compute the prediction root mean square errors (RMSE), Eₗ^{a}(t), as:

$${E}_{t}^{a} ( t ) = \sqrt{\frac{1}{30} {\sum }_{k = {N}_{t} + 1}^{{N}_{t} + 30} {[ {\hat{P}}_{t}^{a} ( k \vert {N}_{t} ) - P ( k ) ]}^{2}} \qquad ( 22 )$$

where P(k) is the actual production rate and l=1, . . . , L.

7) Run each of the L IEKFs to obtain \hat{x}ₗ(Nₜ|Nₜ) directly, and then run the L EKPs. The predicted production rates from these L EKPs are denoted as \hat{P}ₗ^{a}(k, Nₜ), where l=1, . . . , L and k=Nₜ+1, . . . , Nₜ+30.

8) Compute each of the L IEKFs RMSE, Eₗ(t), as:

$${E}_{t} ( t ) = \sqrt{\frac{1}{30} {\sum }_{k = {N}_{t} + 1}^{{N}_{t} + 30} {[ {\hat{P}}_{t} ( k \vert {N}_{t} ) - p ( k ) ]}^{2}} \qquad ( 23 )$$

9) Repeat 2-8 until all data are used, i.e., until tₘₐₓ=50.

10) Compare Eₗ^{a}(t) and Eₗ(t) (t=1, . . . , 50) by computing the following averaged prediction errors (l=1, . . . , L):

$$\begin{matrix} {\overline{E}}_{l}^{a} = \frac{1}{50} \text{?} {E}_{l}^{a} ( t ) & ( 24 ) \\ {\overline{E}}_{l} = \frac{1}{50} \text{?} {E}_{l} ( t ) \\ \text{?} \text{indicates text missing or illegible when filed} & ( 25 )\end{matrix}$$

and the average improvement percentage achieved by the aggregation approach, namely

$${Imp}_{l}^{a} = \frac{{\overline{E}}_{l} - {\overline{E}}_{l}^{a}}{{\overline{E}}_{l}} \times 100 \% , \qquad ( 26 )$$

as well as the mean and standard deviation of I mpₗ^{a}(l=1, . . . , L)

In order to test the aggregation approach described above the aggregation approach was applied to 10 producers. Four different SVMs were constructed (See Appendices A and B): Square-Root LMM (SRLMM), Square-Root DCM (SRDCM), Non-Square-Root LMM (NSRLMM) and Non-Square-Root DCM (NSRDCM). A first set of results from aggregating four combinations of IPRs from two EKSs is shown, and then the results from aggregating all four IPRs are shown.

A. Aggregating IPRs from the SRLMM and SRDCM

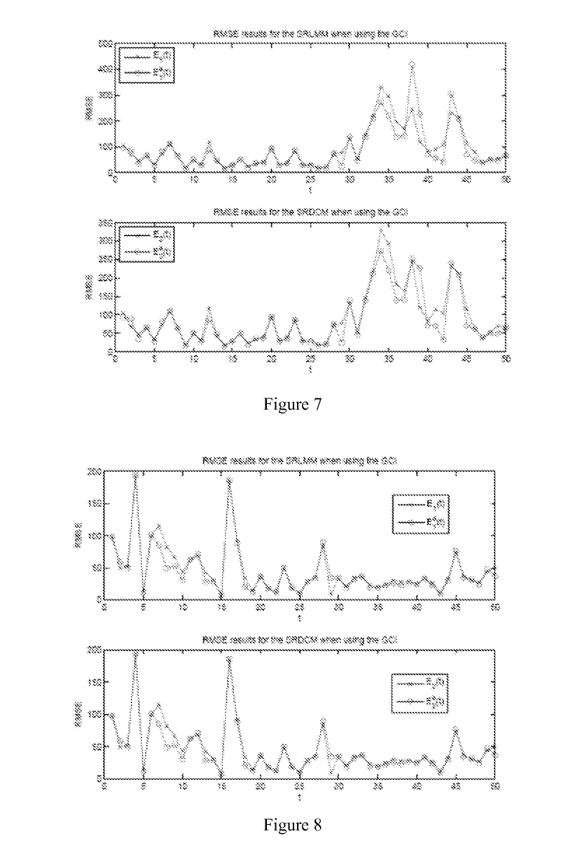

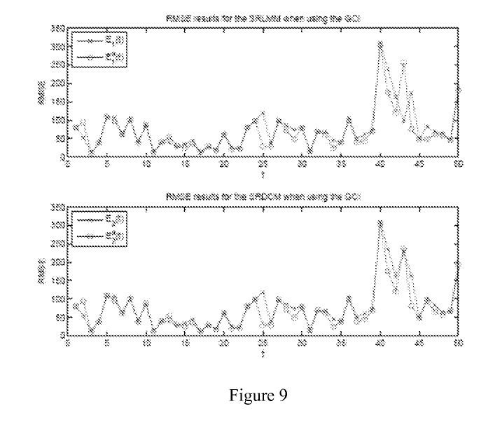

The RMSEs defined in (22) and (23) (L=2) were obtained for three of the producers, namely, Producers 1, 7 and 10 (t=1, . . . , 50). FIGS. 7-9 show the RMSE results for the three producers using the GCI. For all ten producers, the average prediction errors in (24) and (25) (l=1, 2) and the improvement percentages defined in (26) are summarized in Table I.

The GCI was able to decrease the standard deviation of the average prediction errors. On average, the GCI improved the SRLMM by 4.66% and the SRDCM by 5.02%. Additionally the IPR estimates obtained from the SRLMM and SRDCM were found to be very close to each other in this case.

B. Aggregating IPRs from the NSRLMM and NSRDCM

The average results for the GCI are summarized in Table II (cols. 2-7).

C. Aggregating IPRs from the SRLMM and NSRLMM

The average results are also shown in Table II (cols. 8-13).

On average, the GCI improved the SRLMM by 9.21% and the NSRLMM by 9.50%, which is large enough to justify the aggregation.

D. Aggregating IPRs from the SRDCM and NSRDCM

The average results are also summarized in Table II (cols. 14-19). On average, the GCI improves the SRDCM by 9.36% and the NSRDCM by 10.12%, which is large enough to justify the aggregation.

E. Partial Conclusions

Comparing all the results in Tables I and II, it can be observed that the aggregation approach did a much better job when aggregating the SRLMM and NSRLMM and aggregating the SRDCM and NSRDCM than the other two cases, in terms of average prediction error. For the standard deviations of the averaged prediction errors over the ten producers, the GCI gave less standard deviation results for all four cases than those where only the IEKFs were used.

F. Aggregating IPRs from all Four Models

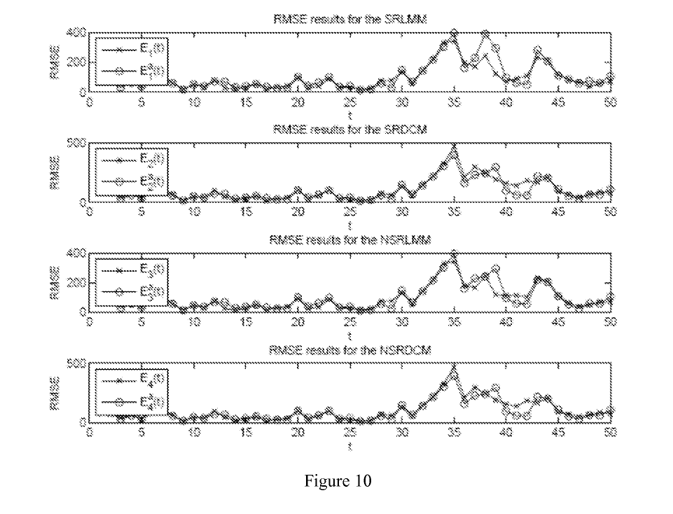

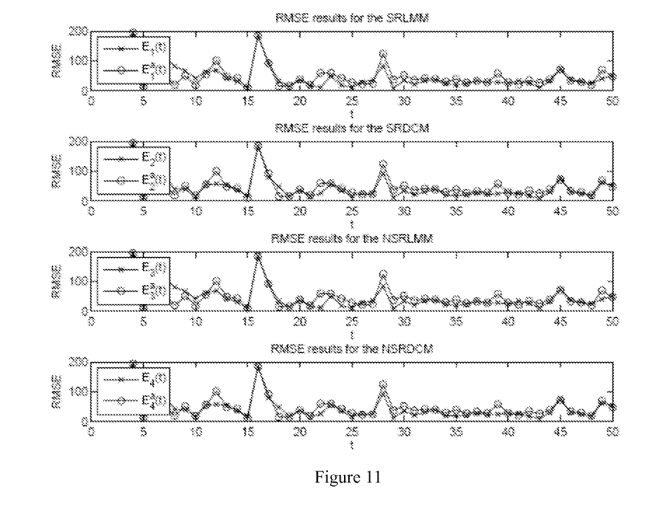

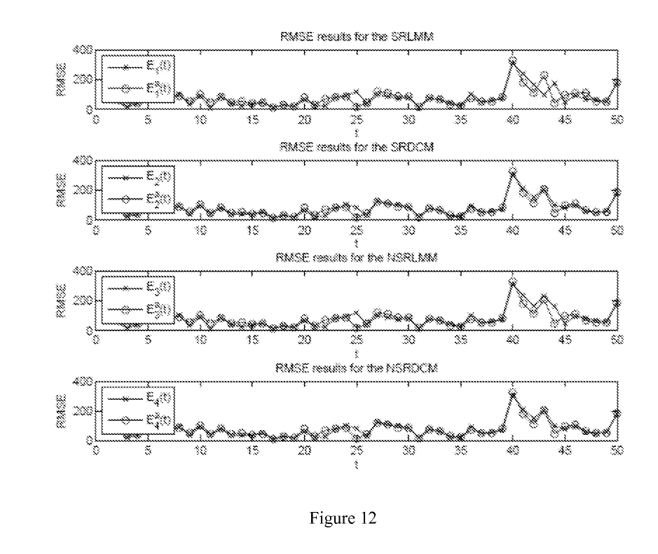

The same ten producers were used as above. Eₗ(t) and Eₗ^{a}(t) (l=1-4) for are shown in FIGS. 10-12. All the averaged results are summarized in Table III. In this case the aggregation actually made the prediction performance worse. Comparing the averaged prediction errors for all five experiments, the results demonstrated that, using the GCI to aggregate the SRDCM and NSRDCM gives the best results.

As will be appreciated, the method as described herein may be performed using a computing system having machine executable instructions stored on a tangible medium. The instructions are executable to perform each portion of the method, either autonomously, or with the assistance of input from an operator. In an embodiment, the system includes structures for allowing input and output of data, and a display that is configured and arranged to display the intermediate and/or final products of the process steps. A method in accordance with an embodiment may include an automated selection of a location for exploitation and/or exploratory drilling for hydrocarbon resources. Where the term processor is used, it should be understood to be applicable to multi-processor systems and/or distributed computing systems.

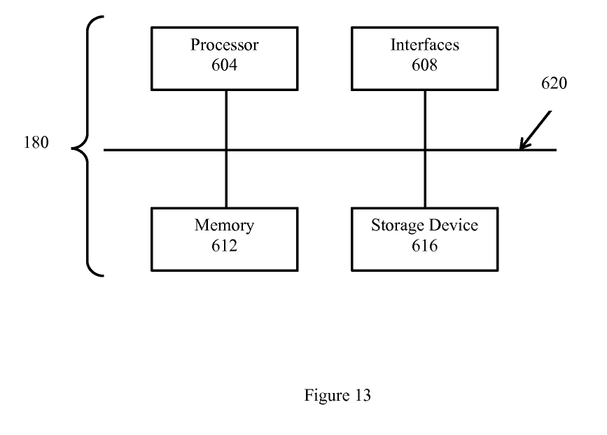

FIG. 13 illustrates a computer 180 that may comprise a general purpose computer programmed with one or more software applications that enable the various features and functions of the invention, as described in greater detail below. In one exemplary implementation, computer 180 may comprise a personal computer. Computer 180 may also comprise a portable (e.g., laptop) computer, a cell phone, smart phone, PDA, pocket PC, or other device. Computer 180 may be configured to execute any or all of the calculation in this disclosure.

Those having skill in the art will recognize that computer 180 may comprise one or more processors 604, one or more interfaces 608 (to various peripheral devices or components), memory 612, one or more storage devices 616, and/or other components coupled via a bus 620. Memory 612 may comprise random access memory (RAM), read only memory (ROM), or other memory. Memory 612 may store computer-executable instructions to be executed by one or more processors 604 as well as data which may be manipulated by the one or more processors 604. Storage devices 616 may comprise floppy disks, hard disks, optical disks, tapes, or other storage devices for storing computer-executable instructions and/or data. One or more software applications may be loaded into memory 612 and run on an operating system of computer 180. In some implementations, an Application Program Interface (API) may be provided to, for example, enable third-party developers to create complimentary applications, and/or to enable content exchange.

Those skilled in the art will appreciate that the disclosed embodiments described herein are by way of example only, and that numerous variations will exist. The disclosure is limited only by the claims, which encompass the embodiments described herein as well as variants apparent to those skilled in the art. In addition, it should be appreciated that structural features or method steps shown or described in any one embodiment herein can be used in other embodiments as well.

We claim:

1. A method of predicting production rates of one or more wells configured to extract petroleum from a petroleum reservoir, the production rates affected by one or more injectors configured to inject water into the petroleum reservoir, the method comprising:
calculating a relationship parameter, using a plurality of models, for each of the one or more wells and an associated one of the one or more injectors;
predicting future values of the relationship parameter calculated using the plurality of models;
calculating a weighted aggregate of the future values of the relationship parameter, wherein weights for the future values are those that minimize a prediction error;
predicting the production rates using the a weighted aggregate.

2. The method of claim 1, wherein the relationship parameter represents a relationship between a step change in injection rate of the one injector and production rate of the one well.

3. The method of claim 1, wherein the plurality of models comprises Liu-Mendel Model.

4. The method of claim 1, wherein the plurality of models comprises a Distributed Capacitance Model.

5. The method of claim 1, wherein the relationship parameter is a function of time.

6. The method of claim 1, wherein the relationship parameter is affected by factors selected from a group consisting of bottom-hole pressures, workovers, geomechanical effects, and combination thereof.

7. The method of claim 1, wherein the future values of the relationship parameter are predicted by Extended Kalman Filter.

8. The method of claim 1, wherein the future values of the relationship parameter are predicted by Extended Kalman Smoother.

9. The method of claim 1, wherein the weights are calculated using quantum particle swarm optimization.

10. The method of claim 1, wherein the plurality of models comprises a Square-Root Liu-Mendel Model.

11. The method of claim 1, wherein the plurality of models comprises a Square-Root Distributed Capacitance Model.

12. The method of claim 1, wherein the plurality of models comprises a Non-Square-Root Liu-Mendel Model.

13. The method of claim 1, wherein the plurality of models comprises a Non-Square-Root Distributed Capacitance Model.

14. The method of claim 1, wherein the weighted aggregate is calculated by calculating a Generalized Choquet Integral.

15. The method of claim 1, wherein using the plurality of model comprises using one or more State-Variable Models (SVMs).

16. The method of claim 15, wherein using one or more SVMs comprises calculating SVMs from injectors within a plurality of ellipses centered at one of the one or more wells.

17. A system comprising a data storage device and a processor, the processor being configured to perform the method of claim 1.

18. A non-transitory computer readable medium encoded with computer executable instructions configured to cause a computer system to perform the method of claim 1.
